(19) United States
(12) Patent Application Publication
(10) Pub. No.: US 2025/0259375 A1
(43) Pub. Date: Aug. 14, 2025

(54) Efficient Ray-Tracing Rendering Processor with Optimization for Mobile Devices and Support of Inverse Rendering

(71) Applicant: Northwestern University, Evanston, IL (US)

(72) Inventors: Jie Gu, Evanston, IL (US); Shiyu Guo, Chicago, IL (US)

(21) Appl. No.: 19/053,742

(22) Filed: Feb. 14, 2025

Related U.S. Application Data
(60) Provisional application No. 63/553,331, filed on Feb. 14, 2024.

(51) Int. Cl. G06T 15/06; G06T 15/00

(52) U.S. Cl. CPC G06T 15/06; G06T 15/005

(57) ABSTRACT

In certain aspects, application-specific integrated circuit (ASIC) comprises a global ray-tracing scheduler (GRTS) in communication with a processing element (PE) array. The ASIC comprises a global memory access controller (GMAC) in communication with the PE array and the GRTS. The ASIC comprises a physical attributes MEM (PAMEM) in communication with the GRTS. The ASIC comprises a reconfigurable mixed-precision processing element of the PE array configured to support an inverse rendering mode for background extraction and a ray-tracing mode.

### CROSS-REFERENCE TO RELATED APPLICATION

The present application claims the benefit of priority under 35 U.S.C. § 119 from U.S. Provisional Patent Application Ser. No. 63/553,331 entitled “Efficient Ray-Tracing Rendering Processor with Optimization for Mobile Devices and Support of Inverse Rendering,” filed on Feb. 14, 2024, the disclosure of which is hereby incorporated by reference in its entirety for all purposes.

### STATEMENT OF FEDERALLY FUNDED RESEARCH OR SPONSORSHIP

This invention was made with government support under grant number CCF-2008906 awarded by the National Science Foundation and under grant number A00804302//FA8650-20-2-7009 awarded by the Department of Defense, Department of the Air Force, Air Force Research Laboratory, University of Minnesota. The government has certain rights in the invention.

### TECHNICAL FIELD

The present disclosure generally relates to image generation and insertion, and more specifically relates to efficient ray-tracing rendering processors with optimization for mobile devices and support of inverse rendering.

### BACKGROUND

As the applications of Augmented Reality (AR) or Virtual Reality (VR) expand rapidly with the growing demands on enhanced visual realism, photorealistic image generation and insertion has become an essential feature for the emerging AR applications providing real-time workplace/household visual assistance. Physically Based Ray-Tracing (PBRT) is often used where synthesized images are generated by simulating the real environment and tracing the light transportation to achieve photorealistic effects, such as reflection, refraction, soft shadows, etc. PBRT is widely used in product design, medical visualization, video games and movie effects. To enable photorealistic rendering, there is a strong demand to support ray-tracing (RT) on mobile devices. However, the challenges are: (1) unstructured memory access pattern and complex control flow lead to scheduling difficulty; (2) high memory requirements exhaust the limited SRAM space on edge devices; (3) low error tolerance requires high precision for computing; (4) complex computations, such as division and square root, require significant computing resources for the edge devices. As a result, common rendering engines are mainly based on the lower cost rasterization rendering technique. Unfortunately, rasterization rendering fails to produce photorealistic synthesis. Few ASICs have been fabricated so far as a mobile RT solution.

The description provided in the background section should not be assumed to be prior art merely because it is mentioned in or associated with the background section. The background section may include information that describes one or more aspects of the subject technology.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 is a schematic diagram illustrating physically-based inverse rendering, according to certain aspects of the present disclosure.

FIG. 2 is a schematic diagram illustrating a physical attributes MEM (PAMEM) utilized in the physically-based inverse rendering of FIG. 1, according to certain aspects of the present disclosure.

FIG. 3 is a schematic diagram illustrating an inverse rendering result of the physically-based inverse rendering of FIG. 1, according to certain aspects of the present disclosure.

FIG. 4 illustrates a constructed 3D background scene, according to certain aspects of the present disclosure.

FIG. 5 illustrates a flow of a ray-tracing rendering algorithm, according to certain aspects of the present disclosure.

FIG. 6 illustrates a flow of a ray generation of the ray-tracing rendering algorithm of FIG. 5, according to certain aspects of the present disclosure.

FIG. 7 illustrates an example ray-tracing computing flow, according to certain aspects of the present disclosure.

FIG. 8 schematically illustrates comparison charts for comparing conventional RT workload versus RT workload of the present disclosure.

FIG. 9 illustrates a background scene memory requirement chart.

FIG. 10 illustrates the top-level architecture of the disclosed technology.

FIG. 11 schematically illustrates a ray-tracing mode in a PE, according to certain aspects of the present disclosure.

FIG. 12 schematically illustrates an inverse rendering mode in a PE, according to certain aspects of the present disclosure.

FIG. 13 illustrates a local PE Controller of each reconfigurable mixed-precision PE, according to certain aspects of the present disclosure.

FIG. 14 is a diagram illustrating PA map memory saving with background clustering by mem size.

FIG. 15 is a diagram illustrating background clustering scheme HW overhead by area.

FIG. 16 is a schematic diagram depicting a scalable 3D model partitioning flow, in RT mode, according to certain aspects of the present disclosure.

FIG. 17 is a block diagram depicting a scalable 3D model partitioning flow, in RT mode, according to certain aspects of the present disclosure.

FIG. 18 chart 136 illustrating normalized run time in percentage versus intersection evaluation, shading, and cast ray for test objects.

FIG. 19 is a schematic diagram illustrating a BBOX intersection evaluator, according to certain aspects of the present disclosure.

FIG. 20 is a chart depicting model size versus memory overhead.

FIG. 21 is a chart depicting runtime in seconds versus model size for a 3D model with scalability runtime.

FIG. 22 is a chart depicting runtime in seconds versus model size for a 3D model without scalability runtime.

FIG. 23 depicts on-chip data movement on the chip in the IR mode, according to certain aspects of the present disclosure.

FIG. 24 depicts on-chip data movement on the chip in the RT mode, according to certain aspects of the present disclosure.

FIG. 25 illustrates multiple PEs having memory access conflicts in RT status mode, according to certain aspects of the present disclosure.

FIG. 26 illustrates a global RT scheduler (GRTS), according to certain aspects of the present disclosure.

FIG. 27 is a chart depicting 42.8× overall speed up from the GRTS.

FIG. 28 is a chart depicting 16× overall speed up from the GMAC.

FIG. 29 is a schematic diagram illustrating RT shading flow, according to certain aspects of the present disclosure.

FIG. 30 is a schematic diagram illustrating PE local shading computation, according to certain aspects of the present disclosure.

FIG. 31 is schematic diagram illustrating the total runtime breakdown for the IR-RT flow and demonstrates the background clustering scheme, according to certain aspects of the present disclosure.

FIG. 32 is a chart depicting relative accuracy for the lighting map, the surface albedo map, the surface normal map, and the depth map.

FIG. 33 illustrates virtual object insertion examples using the IR-RT rendering scheme, according to certain aspects of the present disclosure.

FIG. 34 is a schematic diagram depicting photorealistic effects of refraction, reflection and object shadow, according to certain aspects of the present disclosure.

FIG. 35 is a chart depicting frequency versus voltage with a supply voltage from 0.6V to 0.9V.

FIG. 36 is a chart depicting power versus voltage with a supply voltage from 0.6V to 0.9V.

FIG. 37 is a chart comparing efficiency of the disclosed technology.

FIG. 38 is another chart comparing efficiency of the disclosed technology.

FIG. 39 is a chart comparing power of the disclosed technology.

FIG. 40 illustrates a die micrograph of the chip, according to certain aspects of the present disclosure.

FIG. 41 is a table of specifications of the chip, according to certain aspects of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

Certain aspects of the disclosed technology provides a ray-tracing processor, which supports inverse rendering (IR) for background extraction. Certain key features of the disclosed technology include, but are not limited to: (1) an application-specific integrated circuit (ASIC) rendering processor that embeds end-to-end IR with PBRT solution for AR application on mobile devices, (2) a reconfigurable mixed-precision PE design supporting diverse computing tasks for both IR and RT task, (3) background clustered Field of View (FOV)-focused 3D construction reducing conventional background scene complexity from O(n log n) to O(1), (4) scalable partitioning scheme for complex 3D objects, with an average of 13× speed up on test scenes, (5) use of Global RT Scheduler (GRTS) and Global Memory Access Controller (GMAC) to overcome the challenges of irregular memory access pattern and compute resource with overall 684× speedup compared with the baseline design. The 28 nm test chip achieves 3.95-28.8× higher RT rendering efficiency compared with existing ASIC solutions, enabling real-time PBRT rendering on mobile edge devices.

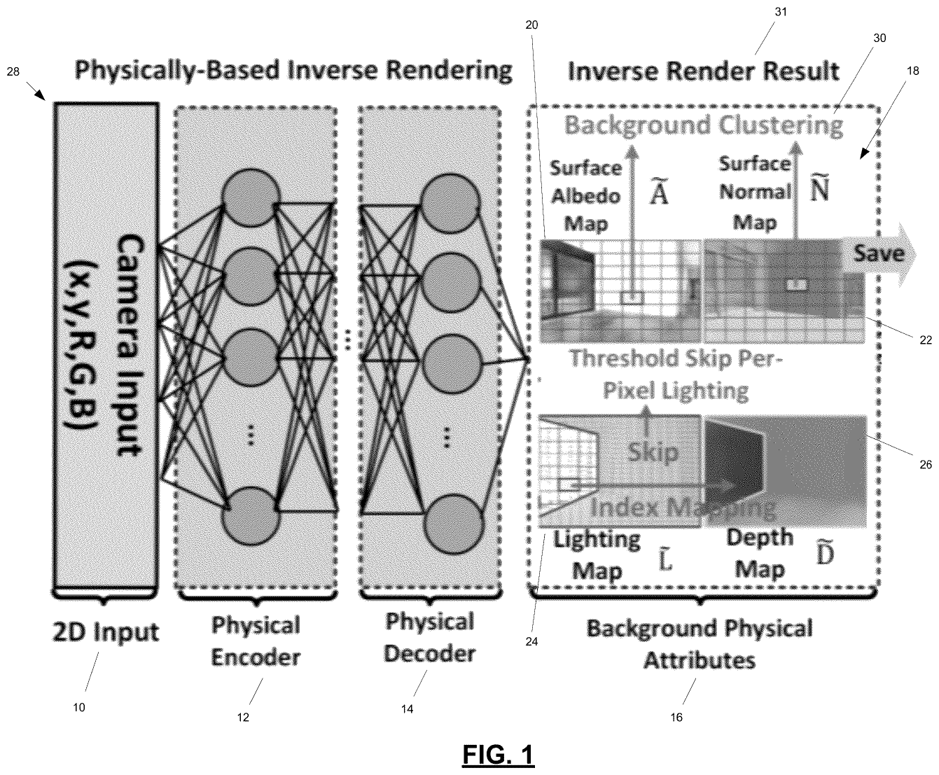

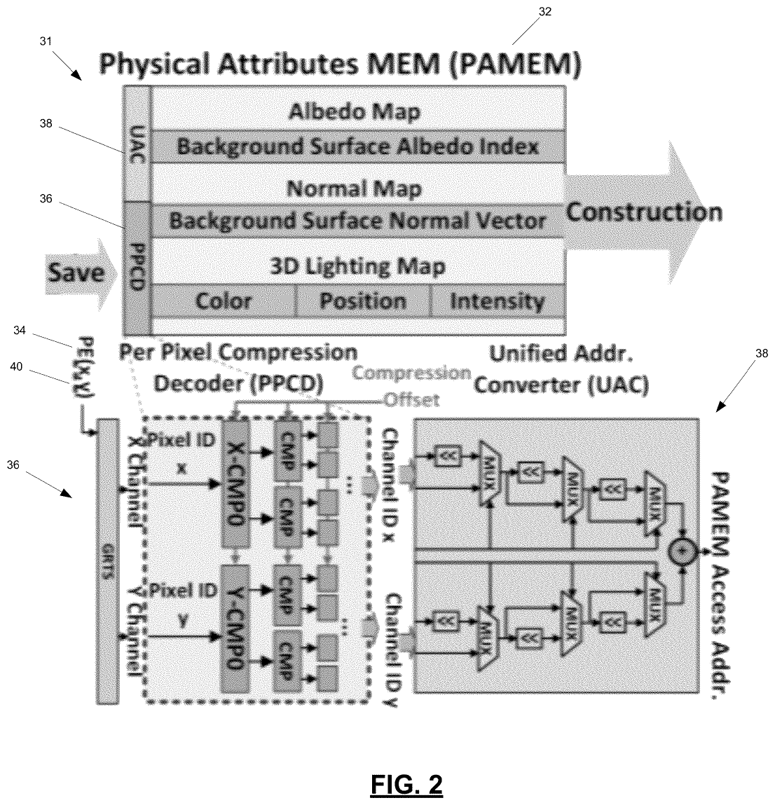

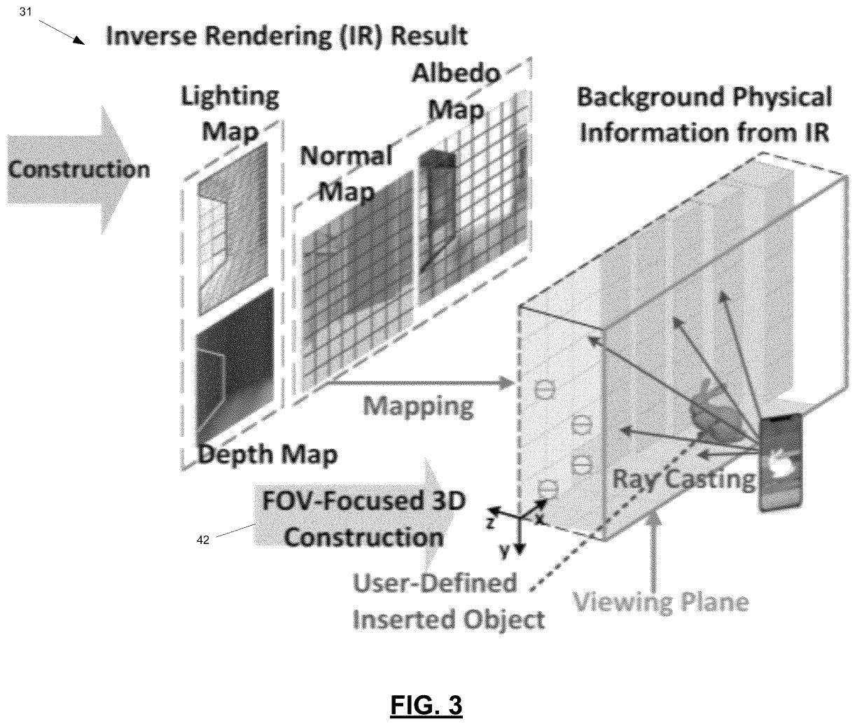

FIGS. 1-7 collectively illustrate a computing flow of the disclosed technology. In the first step, as depicted in FIGS. 1-2, a 2D image 10 captured by a regular camera is sent through a CNN-based physical encoder 12 and a CNN-based physical decoder 14 for inverse rendering (IR) to obtain the background physical attributes 16, including four major background physical attribute (PA) maps 18: a surface albedo map 20, a surface normal map 22, a lighting map 24, and a depth map 26. To save the compressed PA map of the background PA maps 18 on chip 28, a background clustering scheme 30 is utilized based on the similarity of neighbor pixel values of the background map (e.g., the background PA maps 18) by applying an average filter. The IR result PA maps 31 are stored in a Physical Attributes MEM (PAMEM) 32 of the chip 28. In certain aspects, the chip 28 is an ASIC. Each processing element (PE) 34 accessing the PAMEM 32 passes through the Per Pixel Compression Decoder (PPCD) 36 and the Unified Address Converter (UAC) 38 to fetch the corresponding background physical attributes 16 parameter based on the PE task ID 40 from the global ray-tracing scheduler (GRTS) scheme. One PE 34 is one of the many processing cores of the chip 28. In this way, 145-4800× of memory saving for different backgrounds is achieved with 0.06% hardware overhead compared with the baseline design. In the second step, as depicted in FIG. 3, the IR result PA maps 31 are used for Camera FOV-focused 3D construction 42.

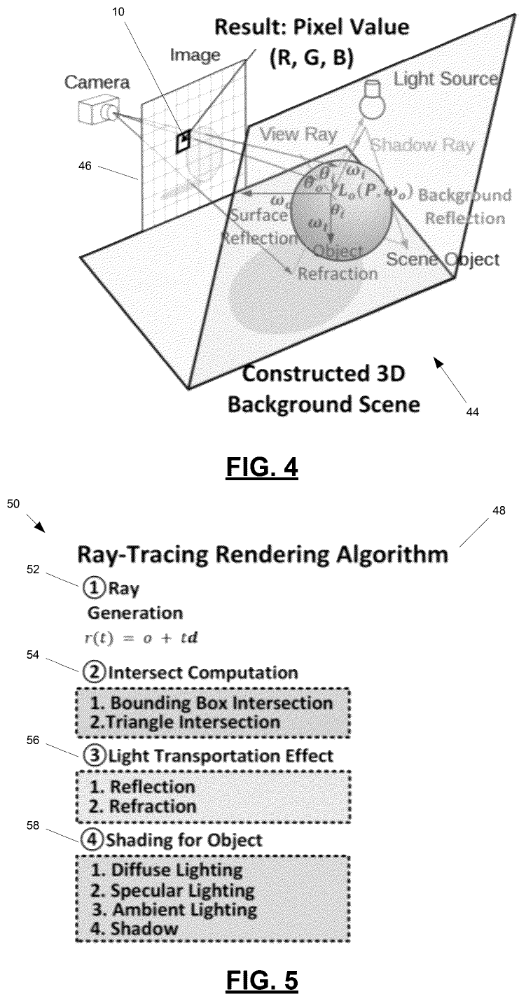

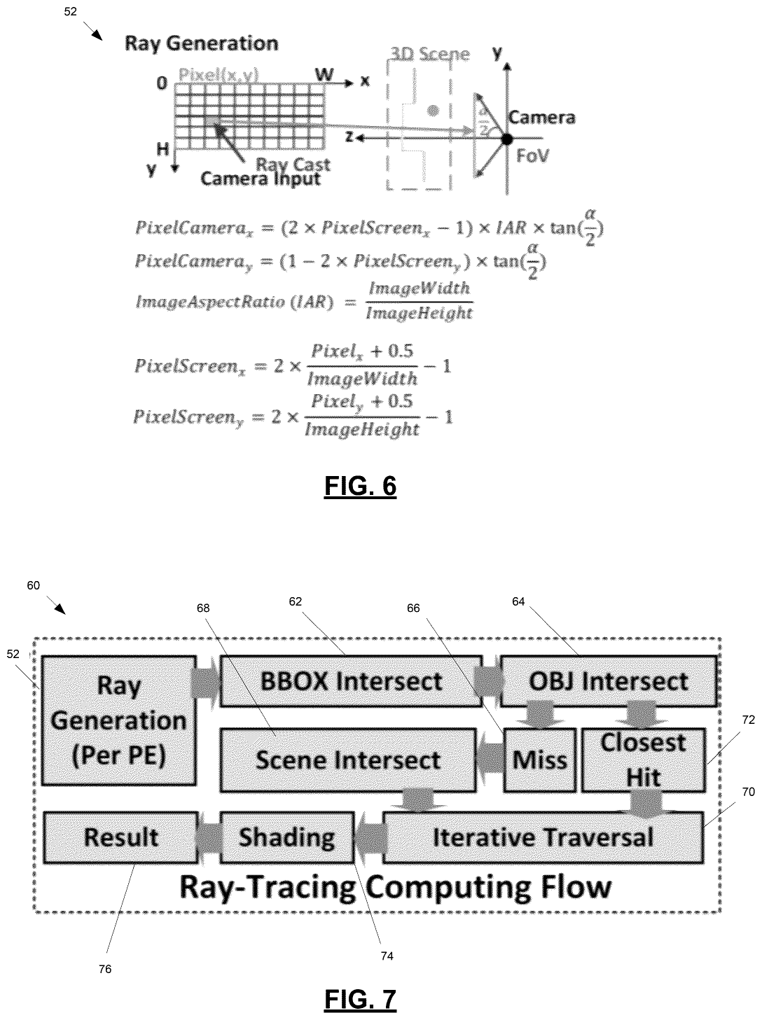

With reference to FIGS. 4-7, the constructed 3D background scene 44 is constructed only for the 3D space covered by the user camera FOV 46. In this way, the constructed 3D background scene 44 complexity is reduced from O(n log n) to O(1) compared with conventional RT solutions. In the last step, Physically Based Ray-Tracing (PBRT) rendering 48 is implemented to render 3D virtual objects with 76% RT workload reduction compared with conventional RT solutions. With reference to FIG. 5, a PBRT flow diagram 50 of the PBRT rendering 48 process is depicted including a ray generation step 52, an intersect computation step 54 (e.g., bounding box intersection and triangle intersection), a light transportation effect step 56 (e.g., reflection and refraction), and a shading for object step 58 (e.g., diffuse lighting, specular lighting, ambient lighting, and shadow). FIG. 6 schematically illustrates details of the ray generation step 52 of FIG. 5. FIG. 7 illustrates an example ray-tracing computing flow diagram 60, which begins with the ray generation step 52 for each PE 34. After the ray generation step 52, the process proceeds to step 62 for Bounding Box (BBOX) intersect. From step 62, the process proceeds to step 64 for Object intersect. If a miss is determined, as depicted at box 66, the process proceeds from step 64 to step 68 for scene intersect and then to step 70 for iterative traversal. On the other hand, if a closet hit is determined, as depicted at box 72, the process proceeds from step 64 to step 70 for iterative traversal. From step 70, the process proceeds to step 74 for shading and then to step 76 for result.

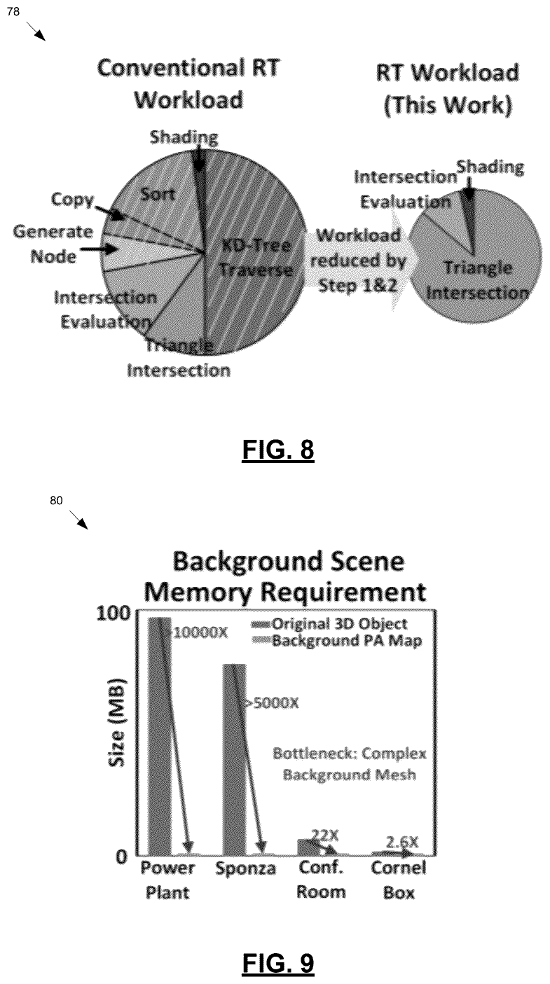

FIG. 8 schematically illustrates comparison charts 78 for comparing conventional RT workload versus RT workload of the present disclosure.

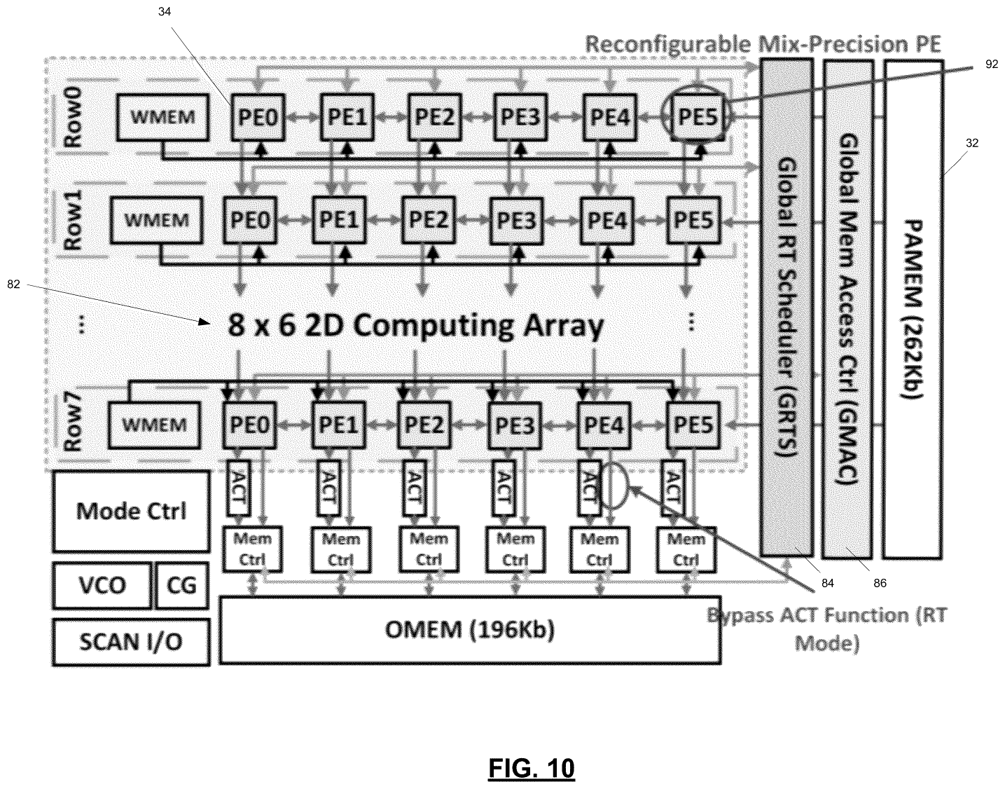

FIG. 9 illustrates a background scene memory requirement chart 80.

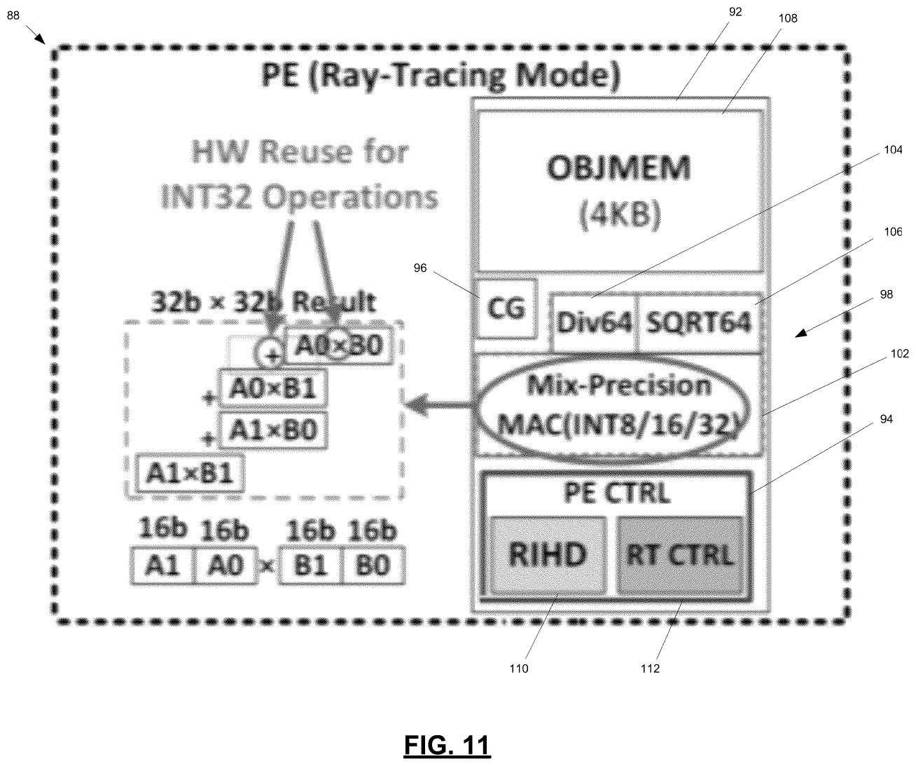

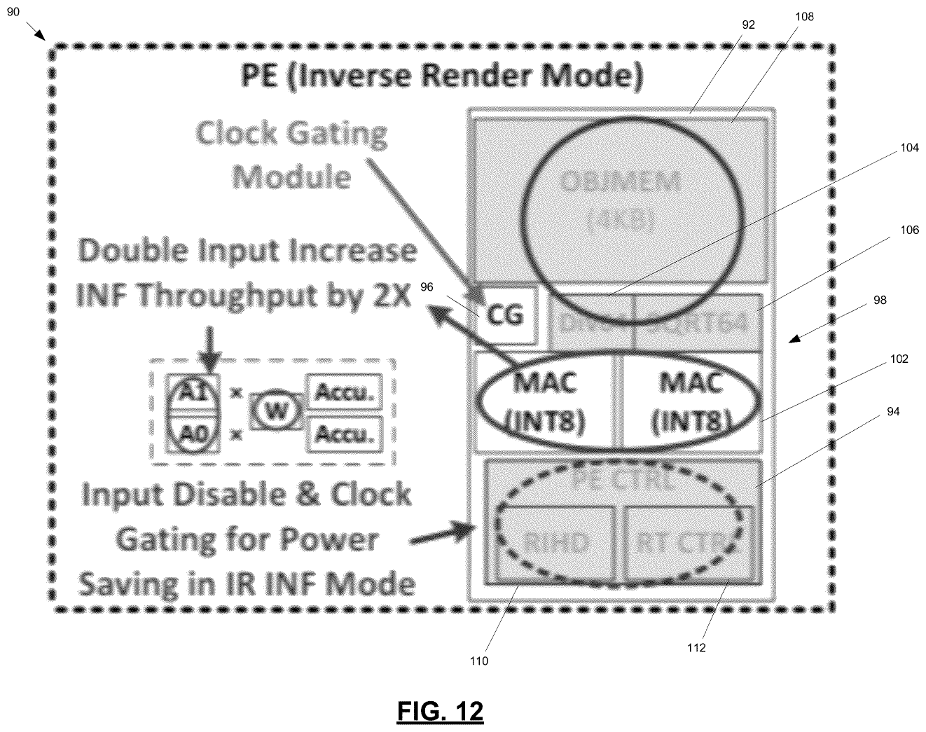

FIG. 10 illustrates the top-level architecture of the disclosed technology. To increase the utilization of the PE 34 and address the irregular access background scene memory requirement chart pattern to memory, an 8×6 PE array 82, for example, is implemented with a global ray-tracing scheduler (GRTS) 84 and a global mem access controller (GMAC) 86. To support computation for both RT mode 88 and IR mode 90, a reconfigurable mixed-precision PE 92 is utilized, as illustrated in FIG. 11 and FIG. 12, respectively. Each reconfigurable mixed-precision PE 92 includes a local PE Controller 94, a clock-gating control 96, a computing core 98, which supports 8b, 16b, and 32b MAC 102, a 64b division module 104, and 64b square root operations module 106, and a local OBJMEM memory 108. Clock gating, via the clock-gating control 96, disables excessive computing units and local MEM in the IR mode 90 and the RT mode 88 with 32% power saving.

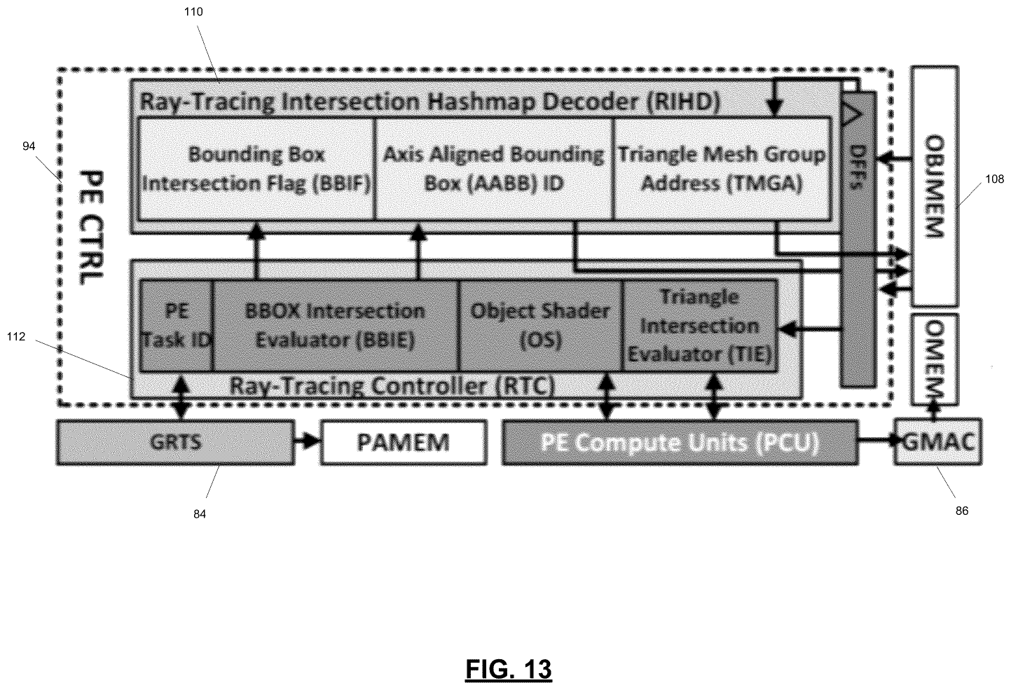

FIG. 13 illustrates the local PE Controller 94 of each reconfigurable mixed-precision PE 92, which includes a ray-tracing intersection hashmap decoder (RIHD) 110 and a ray-tracing controller (RTC) 112.

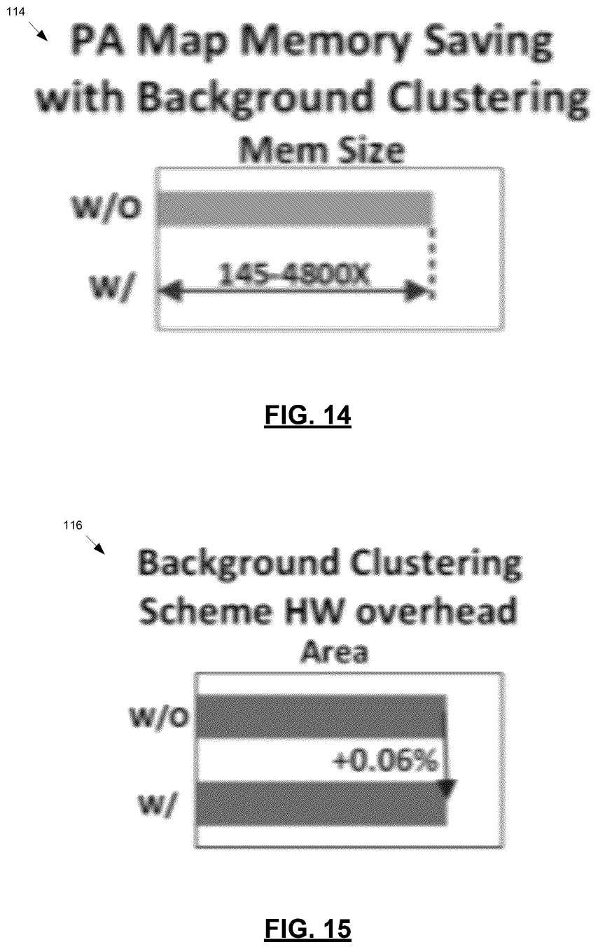

FIG. 14 is a first diagram 114 illustrating PA map memory saving with background clustering by mem size.

FIG. 15 is a second diagram 116 illustrating background clustering scheme HW overhead by area.

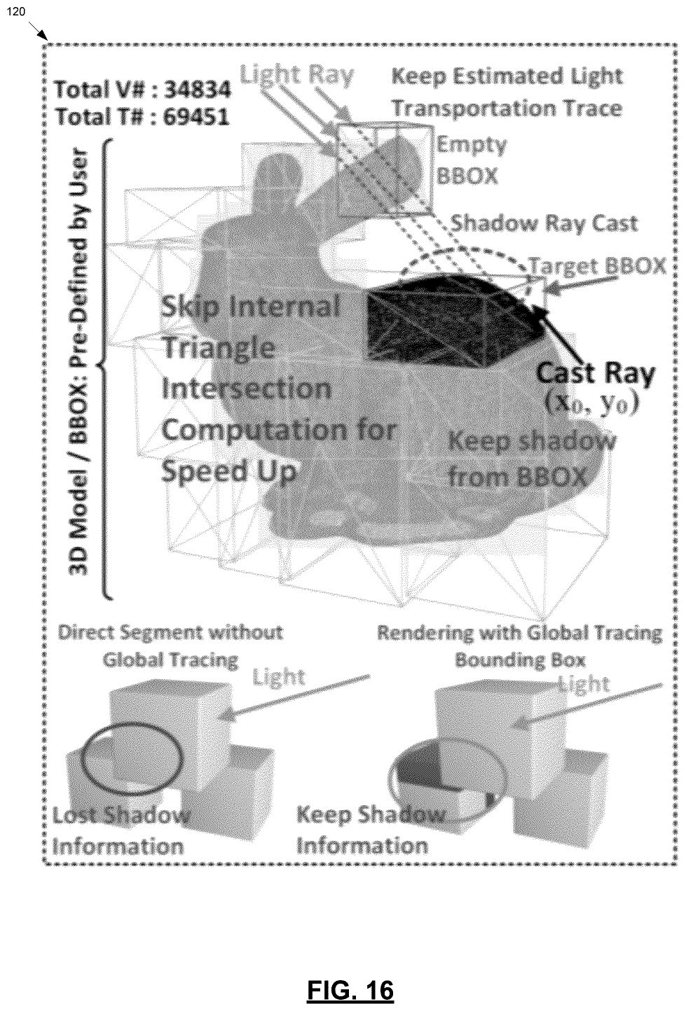

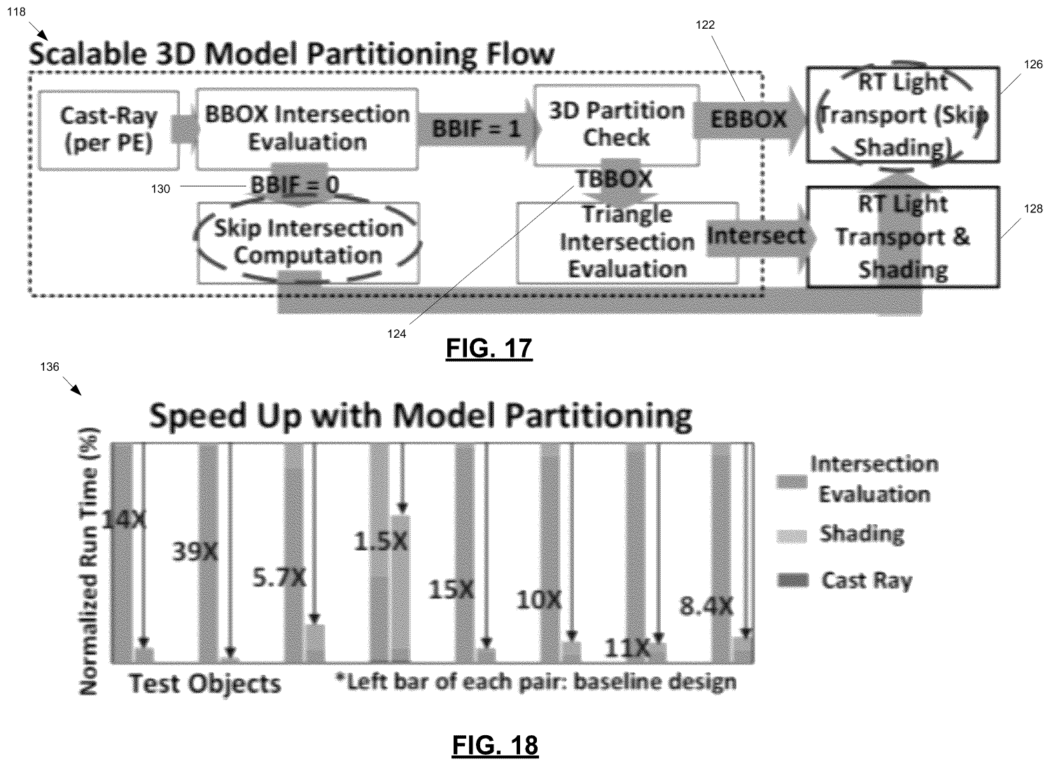

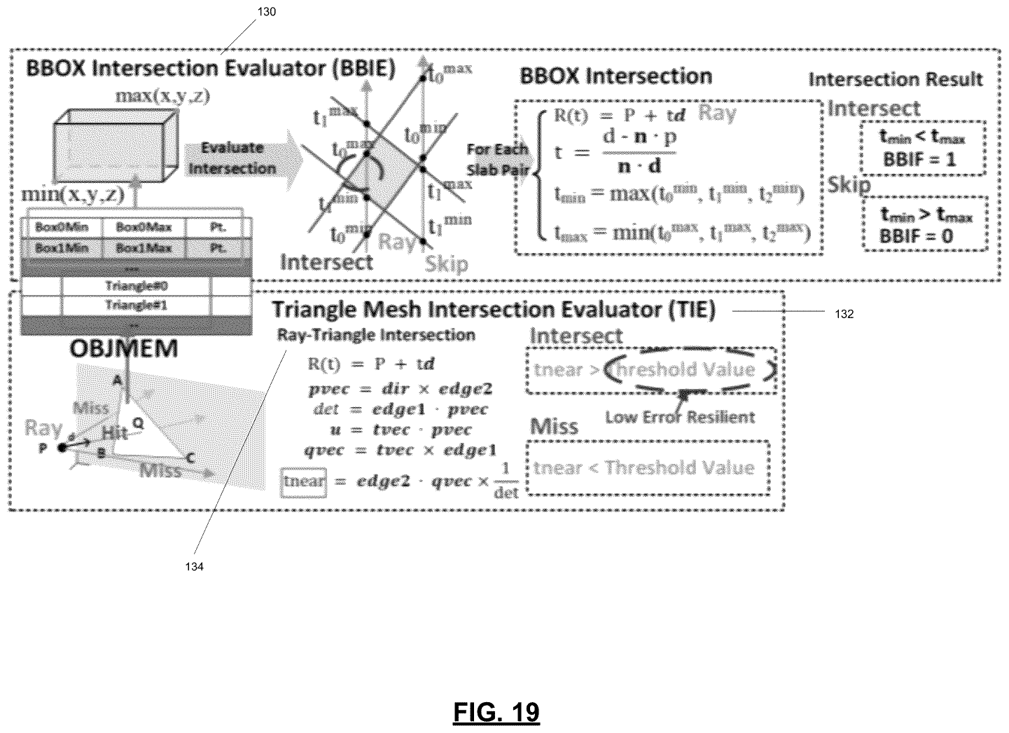

A scalable 3D model partitioning flow 118, in the RT mode 88, will be described with reference to FIGS. 16-19 including the schematic diagram 120 of FIG. 16. In contrast to the conventional solution that builds the BBOX acceleration structure with O(n log n) complexity, the disclosed technology provides two types of object Bounding Box (BBOX): Empty BBOX (EBBOX) 122 and Target BBOX (TBBOX) 124. The EBBOX 122 is only used for light transportation estimation and shadow purposes 126, while the shading computation 128 is skipped. The TBBOX 124 includes a sub-group of user-defined objects inside. With reference to FIG. 19, after the BBOX Intersection Evaluator (BBIE) 130 detects intersection with TBBOX 124, the Triangle Mesh Intersection Evaluator (TIE) 132 computes the ray-triangle intersection 134, and the result is sent for shading computing. With this scheme, complex 3D objects can be segmented for RT processing without losing the ray-tracing effect. As a result, an O(1) scalability in RT rendering time and an average 13× speed up with only 5.6% memory overhead is achieved compared with the baseline design. FIG. 18 is a speed up with model partitioning chart 136 illustrating normalized run time in percentage versus intersection evaluation, shading, and cast ray for test objects.

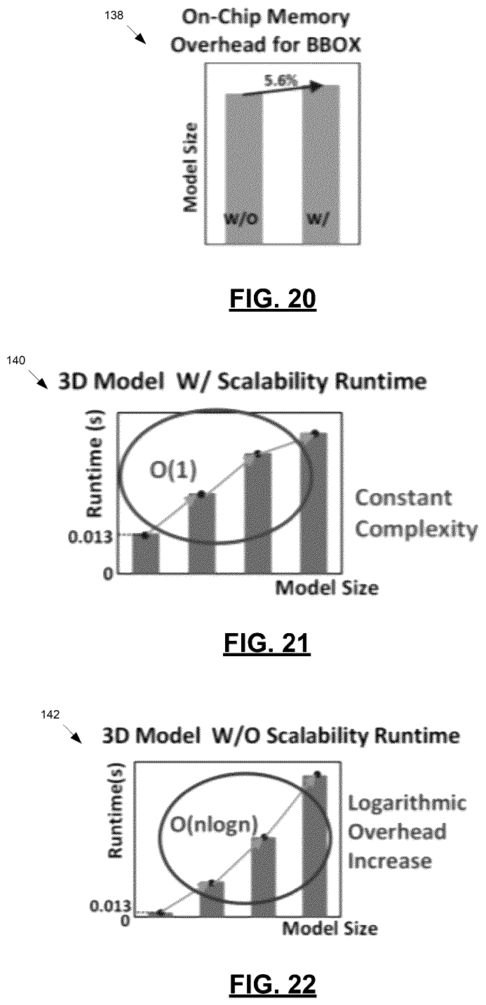

FIG. 20 is an on-chip memory overhead for BBOX chart 138 illustrating model size versus memory overhead.

FIG. 21 is 3D model with scalability runtime chart 140 illustrating runtime in seconds versus model size.

FIG. 22 is 3D model without scalability runtime chart 142 illustrating runtime in seconds versus model size.

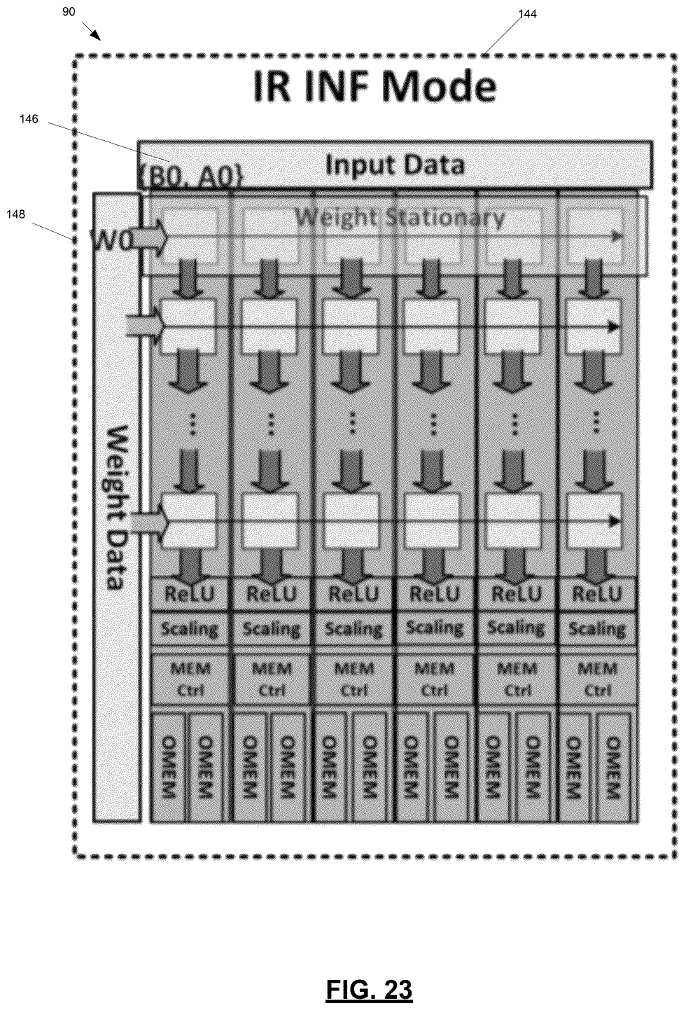

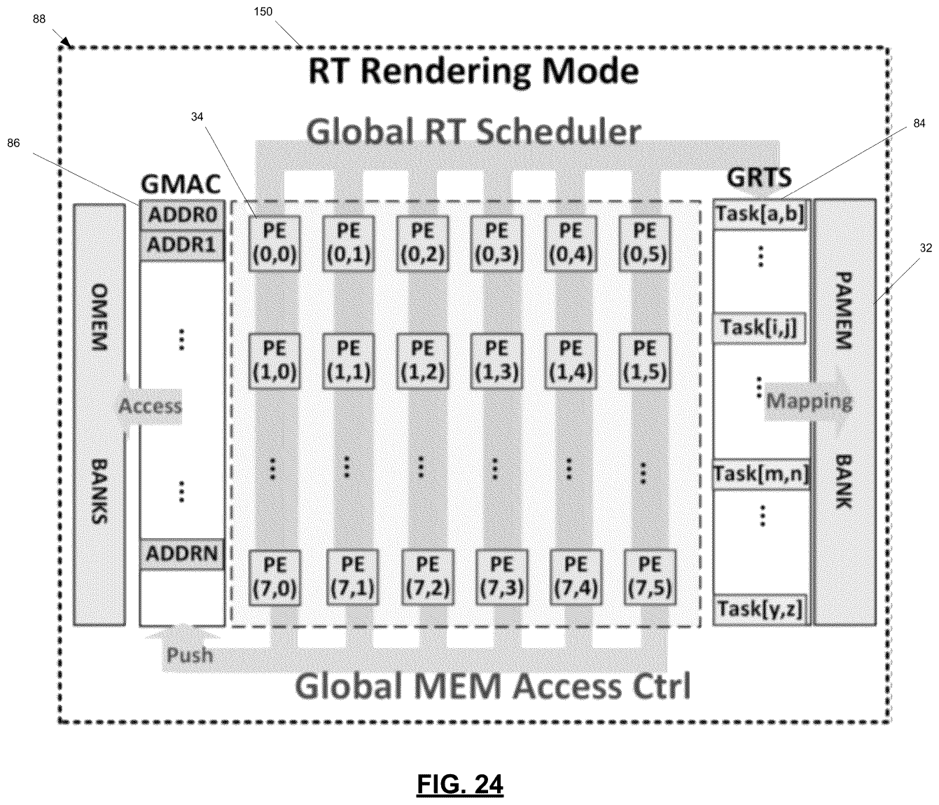

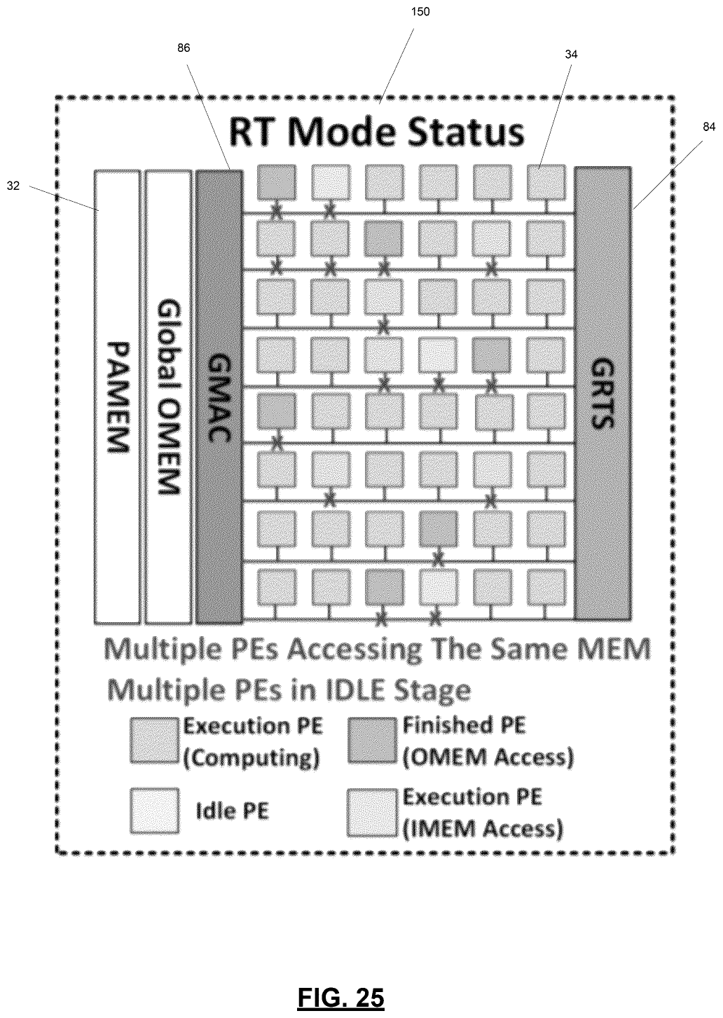

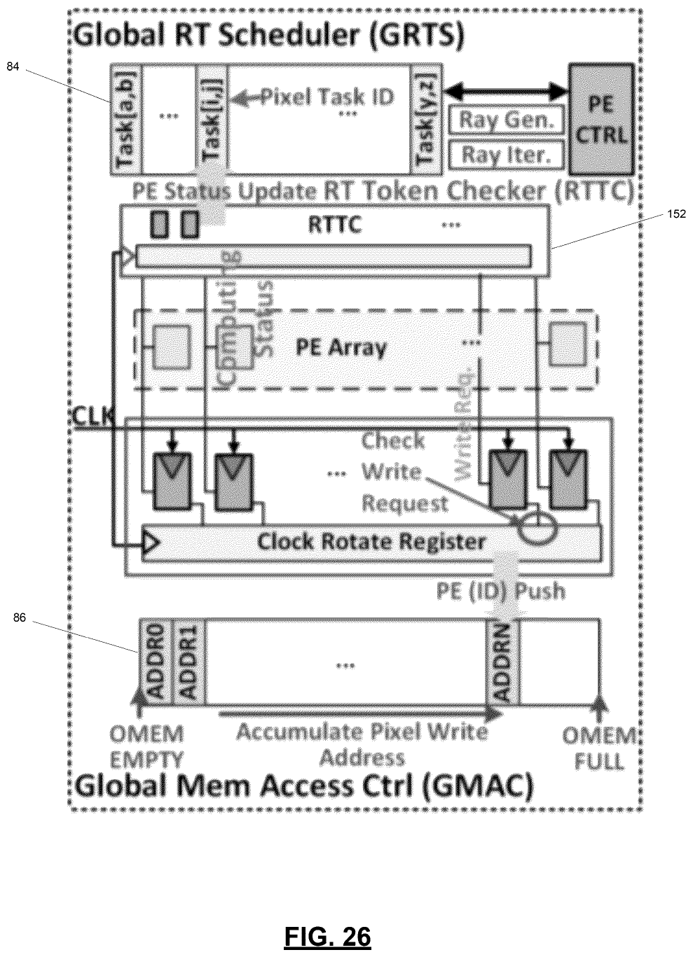

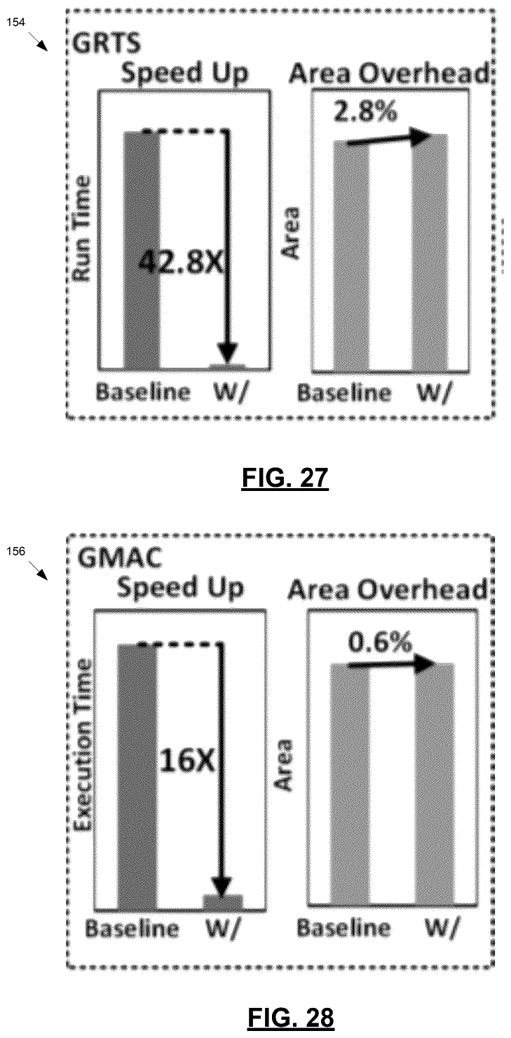

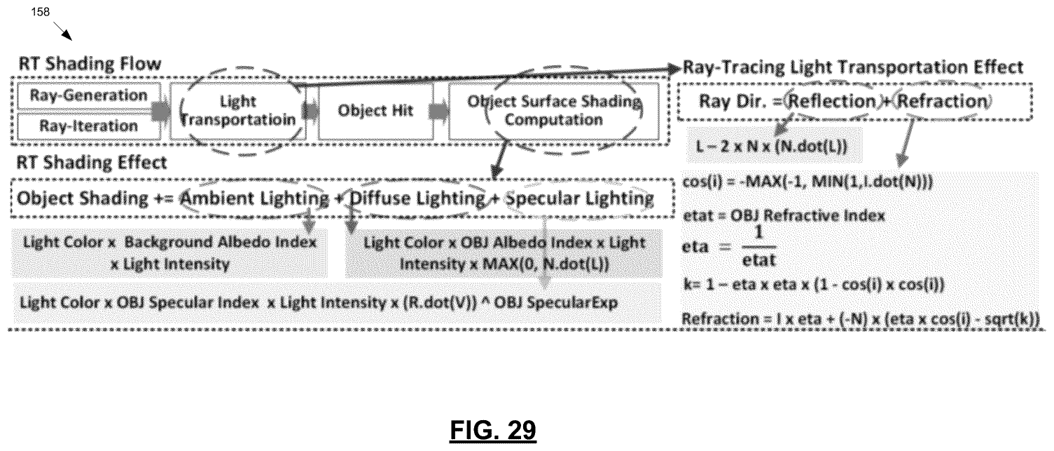

FIG. 23 depicts on-chip data movement on the chip 28 in the IR mode 90. FIG. 24 depicts on-chip data movement on the chip 28 in the RT mode 88. In IR inference mode 144 of the IR mode 90, double input data 146 and double weight stationary data 148 are supported. In RT mode status mode 150 of the RT mode 88, as depicted in FIG. 25, multiple PEs have memory access conflicts. To address the global PAMEM 32 access conflict and increase PE utilization, the GRTS 84 and the GMAC 86 are implemented. With the RT Token Checker (RTTC) 152 checking one PE status every clock cycle, as depicted in FIG. 26, the GRTS 84 and the GMAC 86 process the RTTC selected PE request individually while the GRTS 84 refreshes the checked PE status if the computation is done. In this way, it achieves 42.8× overall speed up from the GRTS 84, as depicted in the chart 154 in FIGS. 27, and 16× overall speed up from the GMAC 86 compared with the baseline design by introducing only 2.8% and 0.6% hardware cost, as depicted in the chart 156 in FIG. 28.

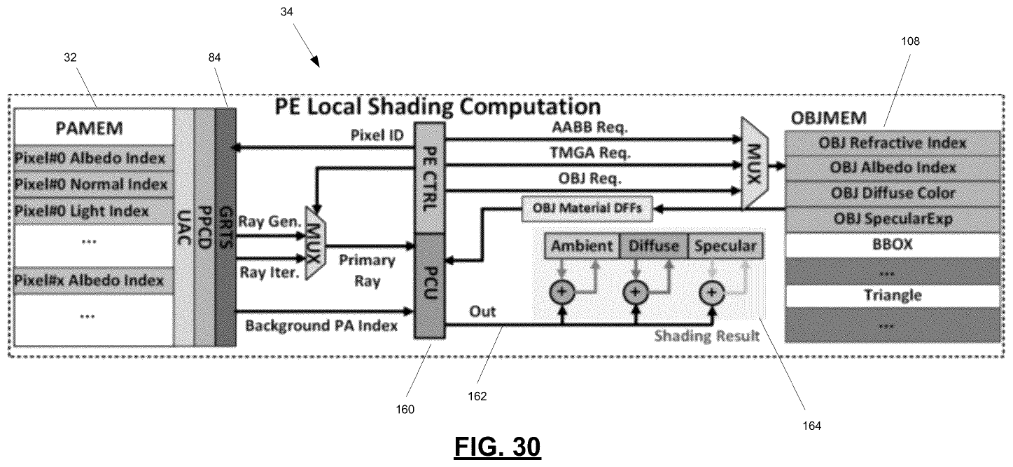

The detailed RT shading algorithm 158 to compute the color of each pixel will be described with reference to FIGS. 29 and 30. RT shading demands complex operations, such as sqrt and division. A PE Compute Unit (PCU) 160 is implemented inside each PE 34. As shown in FIG. 30, data from the PAMEM 32 and data from the OBJMEM 108 are sent to the PCU 160 for shading computation. The PCU output 162 from the PCU 160 is stored in a local shading register 164 for lighting effect accumulation. By implementing the PCU 160 in each PE 34, all the RT computation can be finished individually inside each PE 34.

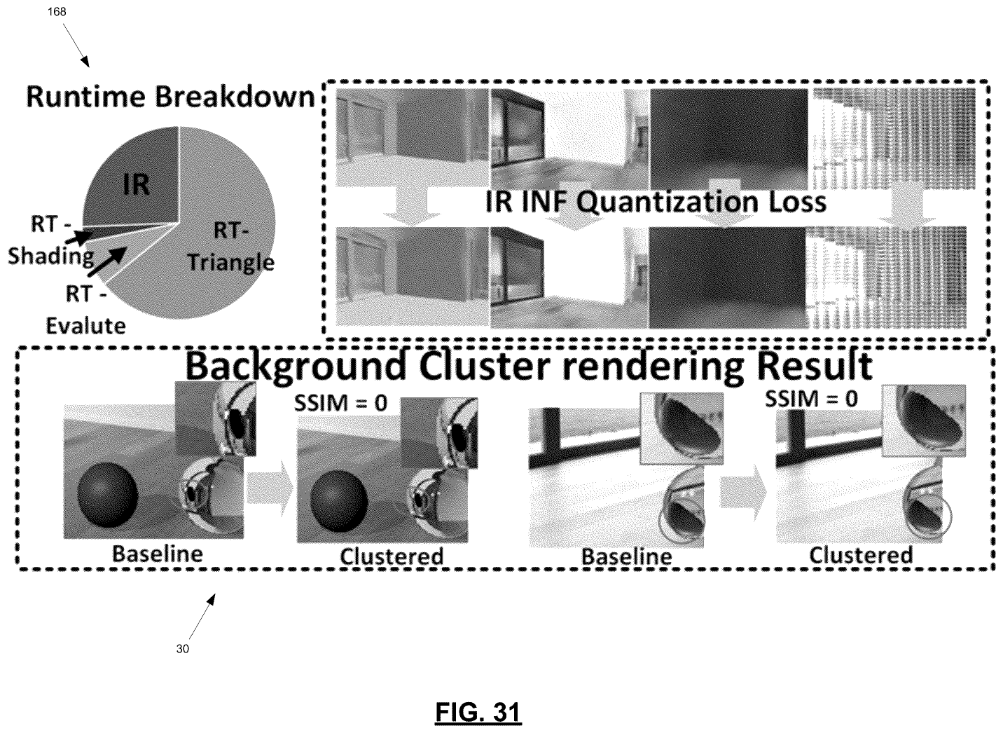

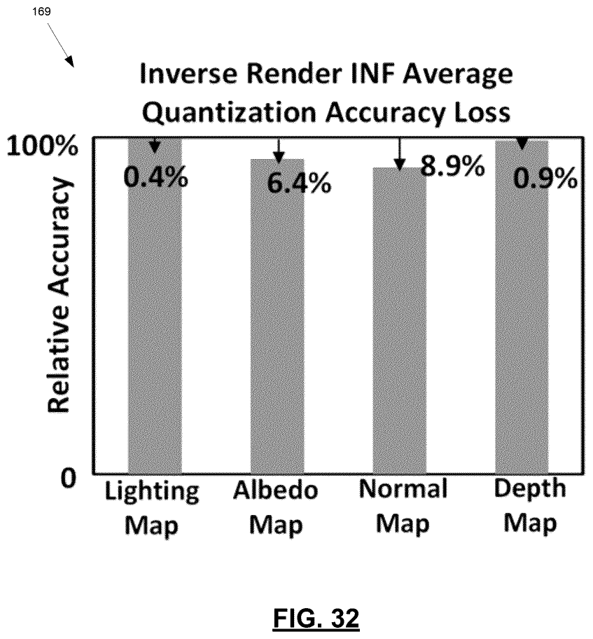

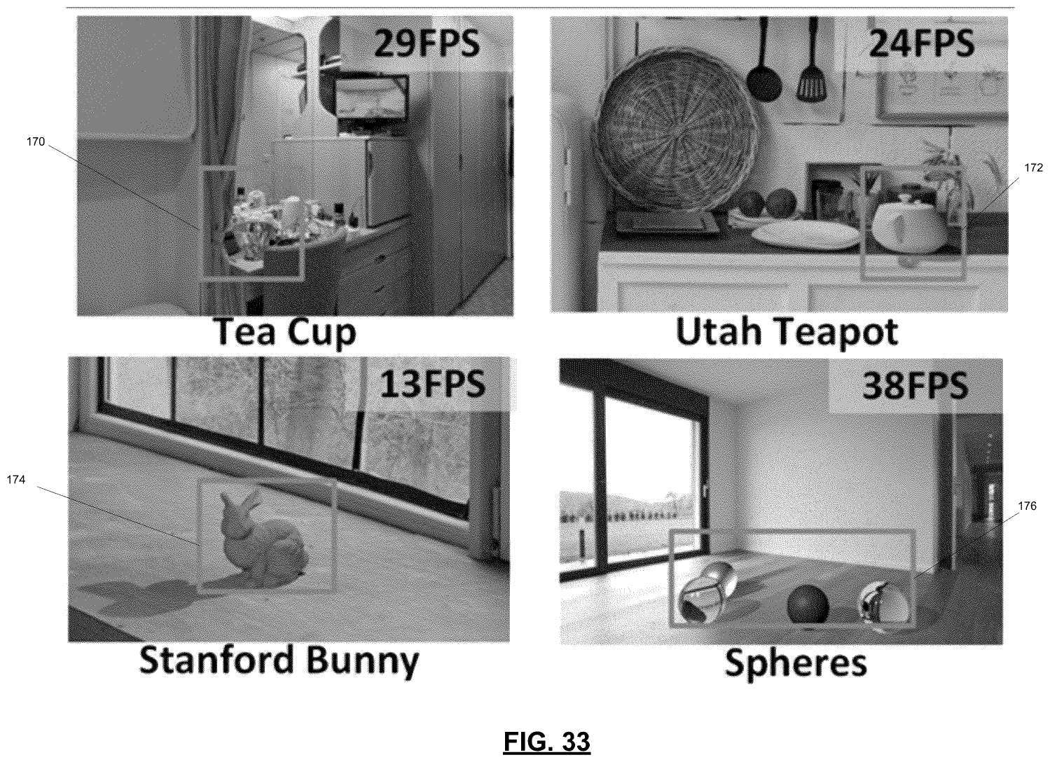

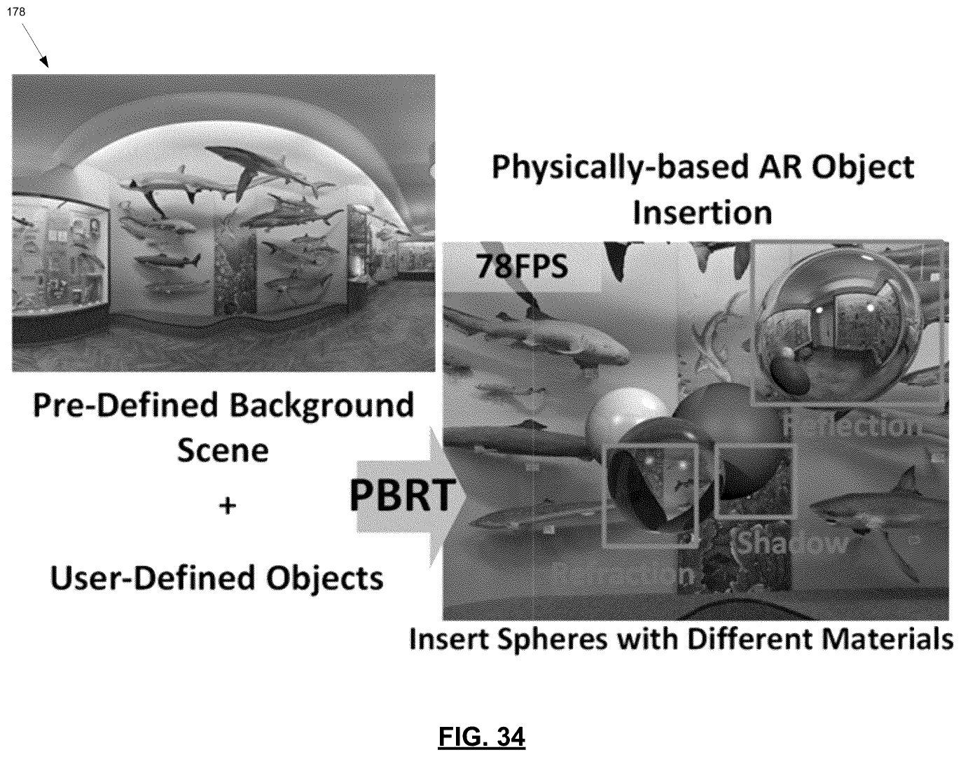

A 28 nm test chip (e.g., the chip 28) is provided with 0.9V nominal supply voltage. FIG. 31 is a schematic diagram 168 illustrating the total runtime breakdown for the IR-RT flow and demonstrates the background clustering scheme 30 by showing the background reflection is able to light up the object properly by using clustered PA map compared with the baseline design with the detailed background PA map. FIG. 32 is an inverse render INF average quantization accuracy loss chart 169 depicting relative accuracy for the lighting map 24, the surface albedo map 20, the surface normal map 22, and the depth map 26. With reference to FIG. 33, four virtual object insertion examples with a teacup 170, an Utah teapot 172, a Stanford bunny 174, and four spheres 176 are demonstrated using the IR-RT rendering scheme. Different materials, such as glass, mirror and ivory are displayed with photorealistic rendering effects of reflection, refraction and shadow. The IR-RT flow achieves an average of 26 fps for real-time RT rendering with complex 3D objects. A RT AR object insertion case without IR inference is also shown in FIG. 5. Four spheres with different materials are inserted. With reference to the schematic diagram 178 of FIG. 34, photorealistic effects of refraction, reflection and object shadow are properly rendered to the image with 78 FPS, meeting the requirement of real-time AR applications.

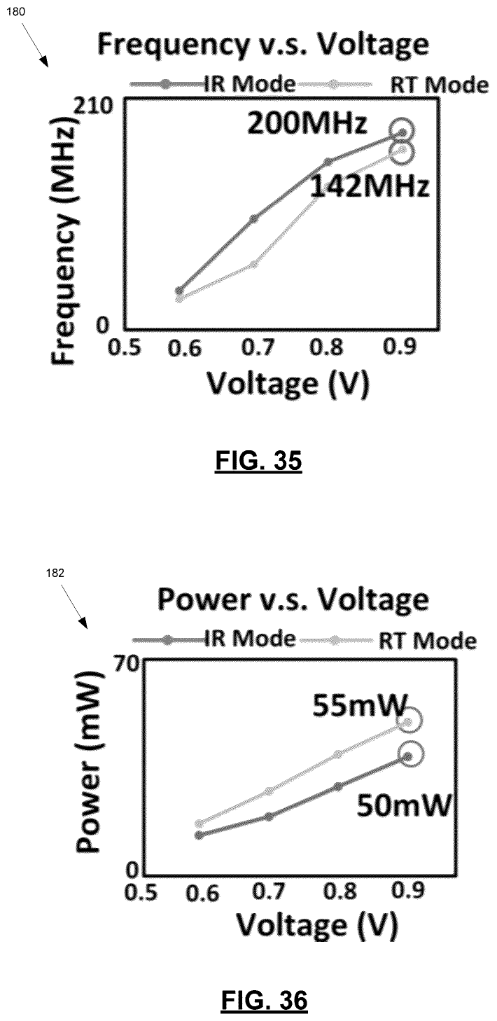

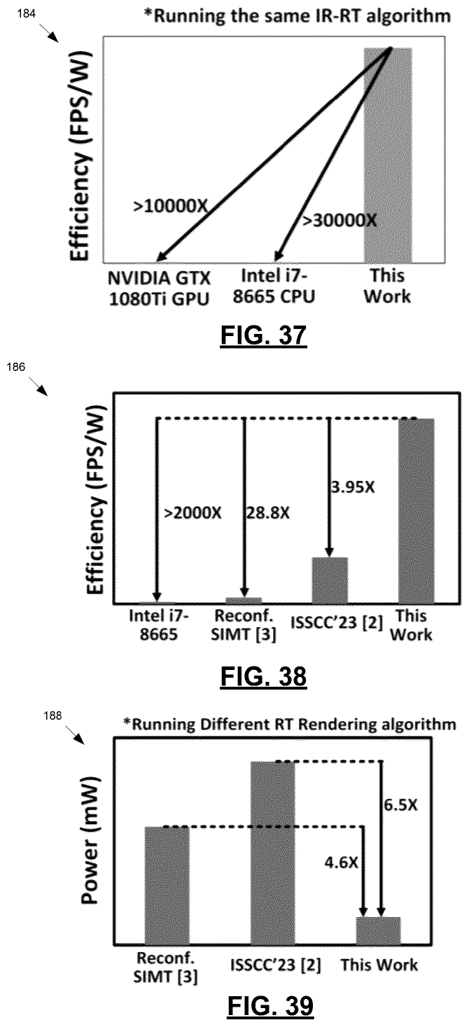

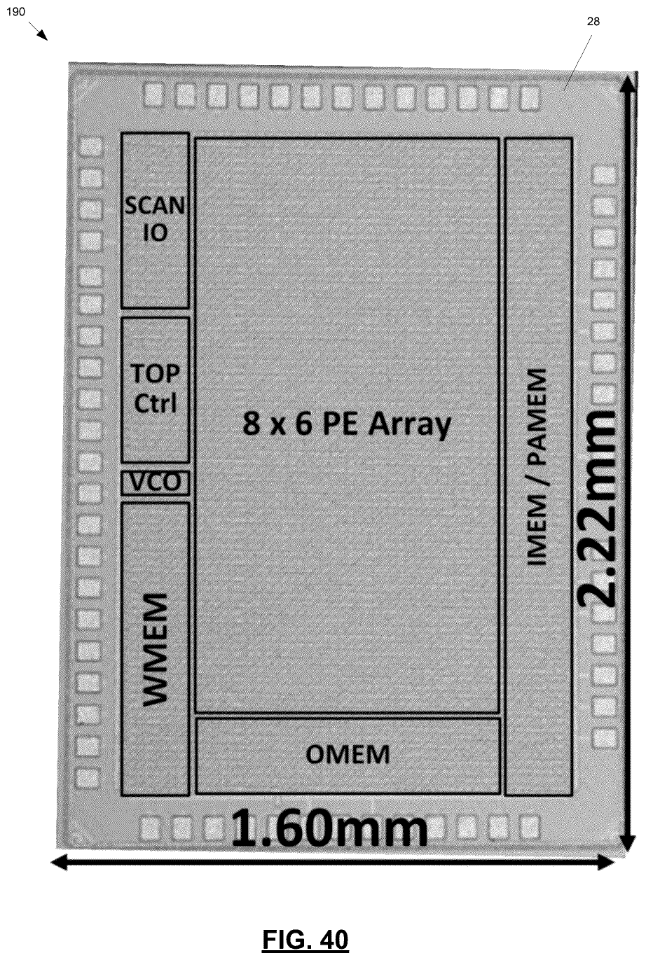

FIGS. 35-39 show measurement and comparison results. FIG. 35 is a frequency versus voltage chart 180 with a supply voltage from 0.6V to 0.9V. FIG. 36 is a power versus voltage chart 182 with a supply voltage from 0.6V to 0.9V. 500 fps/W and 1418 fps/W power efficiency is achieved at 0.9V for the IR mode 90 and the RT mode 88, respectively. FIG. 37 is a comparison chart 184 comparing efficiency of the disclosed technology. FIG. 38 is another comparison chart 186 comparing efficiency of the disclosed technology. FIG. 39 is yet another comparison chart 188 comparing power of the disclosed technology. The disclosed technology implements IR-RT-based rendering solutions, achieving 28.8× and 3.95× higher ray-tracing PBRT on mobile edge devices.

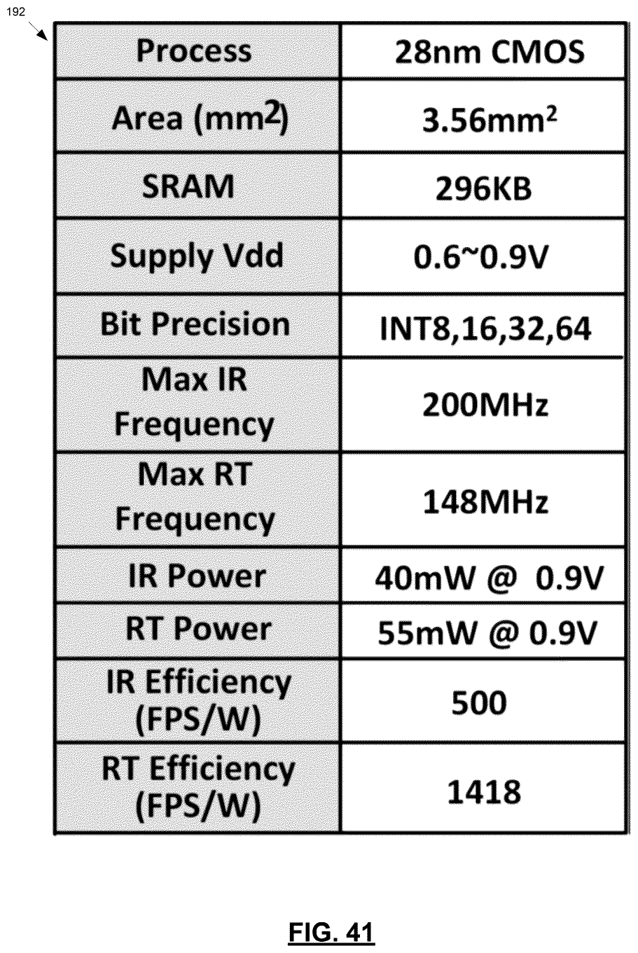

FIG. 40 is a die micrograph 190 of the chip 28. FIG. 41 is a table 192 depicting specifications of the chip 28.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An application-specific integrated circuit (ASIC), comprising:
a processing element (PE) array;
a global ray-tracing scheduler (GRTS) in communication with the PE array;
a global memory access controller (GMAC) in communication with the PE array and the GRTS;
a physical attributes MEM (PAMEM) in communication with the GRTS; and
a reconfigurable mixed-precision processing element of the PE array configured to support an inverse rendering mode for background extraction and a ray-tracing mode.

2. The ASIC of claim 1, wherein, in the inverse rendering mode, the PE array is configured to perform physically based ray-tracing (PBRT) rendering for an augmented reality (AR) application.

3. The ASIC of claim 2, wherein the PBRT rendering comprises ray generation, intersect computation, light transportation effect, and shading.

4. The ASIC of claim 1, wherein the reconfigurable mixed-precision element of the PE array comprises a local processing element controller, a clock-gating control, a computing core, and a local OBJMEM memory.

5. The ASIC of claim 4, wherein the clock-gating control is configured to disable excessive computing units and local MEM.

6. The ASIC of claim 4, wherein each PE of the PE array comprises a PE compute unit configured for shading computation.

7. The ASIC of claim 6, wherein the PE compute unit is configured to receive data from both the PAMEM and the local OBJMEM memory.

8. The ASIC of claim 4, wherein the computing core supports a division module.

9. The ASIC of claim 4, wherein the computing core supports a square root operations module.

10. The ASIC of claim 1, wherein, in the ray-tracing mode, the reconfigurable mixed-precision element of the PE array is configured to perform a scalable 3D model partitioning flow.

11. A mobile device, comprising:
application-specific integrated circuit (ASIC) comprising,
a processing element (PE) array;
a global ray-tracing scheduler (GRTS) in communication with the PE array;
a global memory access controller (GMAC) in communication with the PE array and the GRTS;
a physical attributes MEM (PAMEM) in communication with the GRTS; and
a reconfigurable mixed-precision processing element of the PE array configured to support an inverse rendering mode for background extraction and a ray-tracing mode.

12. The mobile device of claim 11, wherein, in the inverse rendering mode, the PE array is configured to perform physically based ray-tracing (PBRT) rendering for an augmented reality (AR) application.

13. The mobile device of claim 12, wherein the PBRT rendering comprises ray generation, intersect computation, light transportation effect, and shading.

14. The mobile device of claim 11, wherein the reconfigurable mixed-precision element of the PE array comprises a local processing element controller, a clock-gating control, a computing core, and a local OBJMEM memory.

15. The mobile device of claim 14, wherein the clock-gating control is configured to disable excessive computing units and local MEM.

16. The mobile device of claim 14, wherein each PE of the PE array comprises a PE compute unit configured for shading computation.

17. The mobile device of claim 16, wherein the PE compute unit is configured to receive data from both the PAMEM and the local OBJMEM memory.

18. The mobile device of claim 14, wherein the computing core supports a division module.

19. The mobile device of claim 14, wherein the computing core supports a square root operations module.

20. The mobile device of claim 11, wherein, in the ray-tracing mode, the reconfigurable mixed-precision element of the PE array is configured to perform a scalable 3D model partitioning flow.
